(19) United States
(12) Patent Application Publication
(10) Pub. No.: US 2016/0205098 A1
(43) Pub. Date: Jul. 14, 2016

(54) IDENTITY VERIFYING METHOD, APPARATUS AND SYSTEM, AND RELATED DEVICES

(71) Applicant: BEIJING STONE SHIELD TECHNOLOGY CO., LTD., Haidian District Beijing, (CN)

(72) Inventors: Sheng HAN, Beijing (CN); Ying WANG, Beijing (CN)

(73) Assignee: Beijing Stone Sheild Technology Co., Ltd., Beijing (CN)

(21) Appl. No.: 14/898,019

(22) PCT Filed: Jul. 18, 2014
(86) PCT No.: PCT/CN2014/082522

§ 371 Date: Dec. 11, 2015

(30) Foreign Application Priority Data
Jun. 9, 2014 (CN) 201410253630.X

(51) Int. Cl. H04L 29/06; H04L 9/32

(52) U.S. Cl. CPC H04L 63/0884; H04L 9/321; H04L 9/3242; H04L 63/123

(57) ABSTRACT

The invention discloses an identity verifying method, apparatus and system, and related devices so as to improve the security and universality of identity verification. The identity verifying system includes: a verification information generating device configured to generate user identity verification information for identity verification to be performed, wherein the user identity verification information includes at least processed seed information into which seed information is processed using a stored key; and an identity verifying server configured to receive an identity verification request carrying the processed seed information, sent by a terminal device; to search locally stored keys for a key corresponding to the key stored in the verification information generating device; to recover and/or verify the processed seed information using the found key; and to determine from a recovery result or a verification result whether the identity verification is passed.

This application claims the priority to Chinese Patent Application No. 201410253630.X, filed with the State Intellectual Property Office of People's Republic of China on Jun. 9, 2014 and entitled “Identity verifying method, apparatus and system, and related devices”, the content of which is hereby incorporated by reference in its entirety.

### FIELD

The present invention relates to the field of information security technologies and particularly to an identity verifying method, apparatus and system, and related devices.

### BACKGROUND

There are more and more Internet applications available over the Internet along with rapid development of Internet technologies and particularly mobile Internet technologies. When a user accesses these Internet applications, e.g., an email, an instant communication application, a website, etc., providers of the respective Internet applications typically need to verify the identity of the user who logins, in order to secure the access of the user.

At present, in the most popular identity verifying method, a user who is being registered is provided with a username and a password, both of which are typically composed of uppercase and lowercase letters, digits, and characters which can be entered, and if a username and a password, both of which are entered, match the preset username and password, then the user can pass the verification. In an Internet application requiring higher security, e.g., an online bank, an online payment application, etc., other secondary identity verifying means may typically be further adopted, e.g., a verification code for a mobile phone, an RSA-SecurID dual-factor verification token, a smart card, etc.

In the various identity verifying methods above, the most popular identity verifying method is to verify the identity using the username and the password, but both the username and the password are somewhat limited in length, where if the password is set too short and simple, then it may be easily cracked; and if the password is set too long and complex, then it may not be convenient to memorize. Moreover the username and the password being entered via a keypad may be easily stolen by malicious codes in a terminal device, thus degrading the security in verifying the identity.

If the verification code for the mobile phone is adopted as secondary identity verifying means, then since malicious codes easily injected into the smart mobile phone may intercept the verification code for the mobile phone, distributed by the network side, the security in verifying the identity cannot be guaranteed. The smart card limited in hardware may be difficult to popularize and be poor in universality. The RSA-SecurID dual-factor verification token is widely applied in important information systems all over the world, but since 6 digits are used for verification, the verification token can only be used as a verification code instead of the username and the primary password to verify the identity; and this method can only be applicable to a separate information system instead of being universally applied, so that the user typically has to hold a number of different SecurID tokens.

As can be apparent, it has been highly desirable in the prior art to address the technical problem of how to improve the security and universality of identity verification.

### SUMMARY

Embodiments of the invention provide an identity verifying method, apparatus and system, and related devices so as to improve the security and universality of identity verification.

An embodiment of the invention provides an identity verifying system including:

a verification information generating device configured to generate user identity verification information for identity verification to be performed, wherein the user identity verification information includes at least processed seed information into which seed information is processed using a stored key, and the seed information is any information that can be processed by a computer system; and

an identity verifying server configured to receive an identity verification request carrying the processed seed information, sent by a terminal device, wherein the processed seed information is obtained by the terminal device from the user identity verification information obtained from the verification information generating device; to search locally stored keys for a key corresponding to the key stored in the verification information generating device; to recover and/or verify the processed seed information using the found key; and to determine from a recovery result or a verification result whether the identity verification is passed.

An embodiment of the invention provides an identity verifying method at the network side including:

receiving an identity verification request sent by a terminal device, wherein the identity verification request carries user identity verification information obtained by the terminal device from a verification information generating device, the user identity verification information includes at least processed seed information into which the verification information generating device processes seed information using a stored key, and the seed information is any information that can be processed by a computer system;

searching locally stored keys for a key corresponding to the key stored in the verification information generating device;

recovering and/or verifying the processed seed information using the found key; and

determining from a recovery result or a verification result whether the identity verification is passed.

An embodiment of the invention provides an identity verifying apparatus at the network side including:

a receiving unit configured to receive an identity verification request sent by a terminal device, wherein the identity verification request carries user identity verification information obtained by the terminal device from a verification information generating device, the user identity verification information includes at least processed seed information into which the verification information generating device processes seed information using a stored key, and the seed information is any information that can be processed by a computer system;

a searching unit configured to search locally stored keys for a key corresponding to the key stored in the verification information generating device;

a processing unit configured to recover and/or verify the processed seed information using the key found by the searching unit; and

an identity verifying unit configured to determine from a recovery result or a verification result whether the identity verification is passed.

An embodiment of the invention provides an identity verifying server including the identity verifying apparatus at the network side above.

An embodiment of the invention provides an identity verifying method at the terminal side including:

sending an identity verification request to an identity verifying server at the network side for identity verification in an access to an Internet application, wherein the identity verification request carries user identity verification information obtained from a verification information generating device, and the user identity verification information includes at least processed seed information into which the verification information generating device processes seed information using a stored key, wherein the seed information is any information that can be processed by a computer system; and

receiving an Allow/Reject Access response message returned by an application server corresponding to the Internet application, wherein the response message is sent by the application server according to an identity verification result returned by the identity verifying server.

An embodiment of the invention provides an identity verifying apparatus at the terminal side including:

a sending unit configured to send an identity verification request to an identity verifying server at the network side for identity verification in an access to an Internet application, wherein the identity verification request carries user identity verification information obtained from a verification information generating device, the user identity verification information includes at least processed seed information into which the verification information generating device processes seed information using a stored key, and the seed information is any information that can be processed by a computer system; and

a receiving unit configured to receive an Allow/Reject Access response message returned by an application server corresponding to the Internet application, wherein the response message is sent by the application server according to an identity verification result returned by the identity verifying server.

An embodiment of the invention provides a terminal device including the identity verifying apparatus at the terminal side above.

With the identity verifying method, apparatus and system, and related devices according to the embodiments of the invention, user identity verification information generated by a verification information generating device for identity verification to be performed can be obtained by a terminal device, thus processed seed information included in the user identity verification information can be obtained. Particularly the verification information generating device processes seed information using a locally stored key, the terminal device sends the obtained processed seed information to a identity verifying server at the network side, and the identity verifying server searches locally stored keys for a key corresponding to the key stored in the verification information generating device, recovers and/or verifies the processed seed information using the found key and determines from a recovery result or a verification result whether the identity verification is passed. In above process, on the one hand, the user need not memorize usernames and passwords, and can be verified directly through a terminal obtaining user identity verification information to thereby simplify user operation; on the other hand, the user identity verification information generated according to processed seed information is far more complex than a password which can be memorized by a person and is unique and non-repeatable, thus it cannot be reused and falsified even if it is listened, thereby improving the security of identity verification. Additionally, the identity verifying method according to the embodiment of the invention can be also applicable to a scenario in which an identity needs to be verified, thereby improving the universality of the identity verifying method.

Other features and advantages of the invention will be set forth in the following description, and will partly become apparent from the description or can be learned from the practice of the invention. The object and other advantages of the invention can be attained and achieved from the structures particularly pointed out in the written description, claims, and drawings.

### BRIEF DESCRIPTION OF THE DRAWINGS

The drawings described here are intended to provide further understanding of the invention and to constitute a part of the invention, and the exemplary embodiments of the invention and the description thereof are intended to illustrate the invention but not to limit the invention unduly. In the drawings:

FIG. 1 illustrates a schematic structural diagram of an identity verifying system according to an embodiment of the invention;

FIG. 2 illustrates a schematic flow chart of information interaction in the identity verifying system according to an embodiment of the invention;

FIG. 3 illustrates a schematic flow chart of an implementation of an identity verifying method at the network side according to an embodiment of the invention;

FIG. 4 illustrates a schematic structural diagram of an identity verifying apparatus at the network side according to an embodiment of the invention;

FIG. 5 illustrates a schematic flow chart of an implementation of the identity verifying method at the terminal side according to an embodiment of the invention; and

FIG. 6 illustrates a schematic structural diagram of an identity verifying apparatus at the terminal side according to an embodiment of the invention.

### DETAILED DESCRIPTION OF THE EMBODIMENTS

In order to improve the security and universality of an identity verifying system, embodiments of the invention provide an identity verifying method, apparatus and system, and related devices.

Preferred embodiments of the invention will be described below with reference to the drawings, but it shall be appreciated that the preferred embodiments described here are merely intended to describe and illustrate the invention but not to limit the invention, and the embodiments of the invention and features thereof can be combined with each other unless there is confliction between them.

### First Embodiment

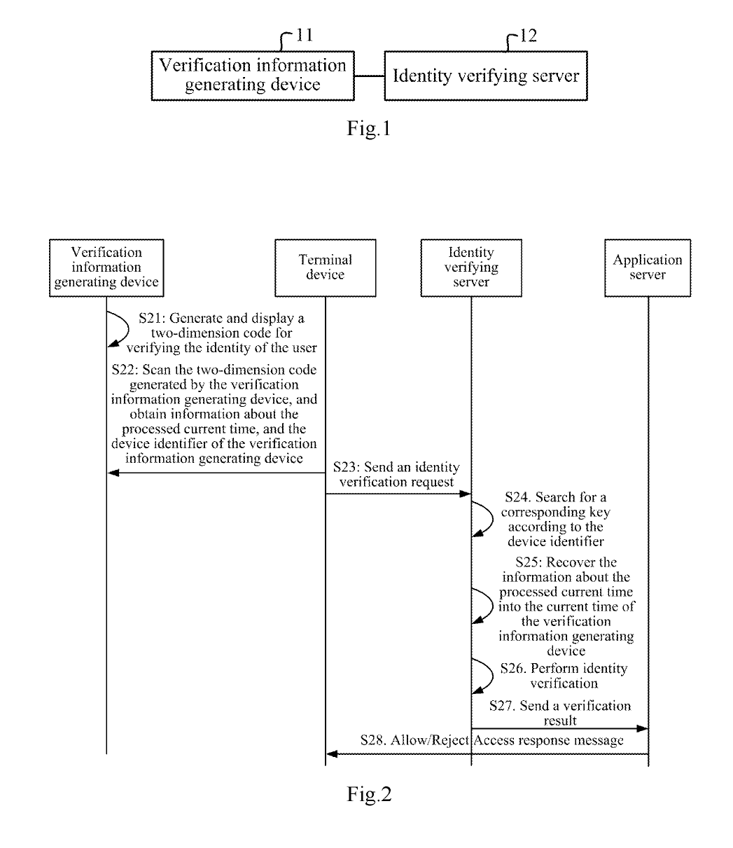

As illustrated in FIG. 1, there is a schematic structural diagram of an identity verifying system according to an embodiment of the invention, the identity verifying system includes a verification information generating device and an identity verifying server, where:

The verification information generating device 11 is configured to generate user identity verification information for identity verification to be performed, where the user identity verification information includes at least processed seed information into which seed information is processed using a stored key; and

The identity verifying server 12 is configured to receive an identity verification request carrying the processed seed information, sent by a terminal device, where the processed seed information is obtained by the terminal device from the user identity verification information obtained from the verification information generating device 11; to search locally stored keys for a key corresponding to the key stored in the verification information generating device 11; to recover and/or verify the processed seed information using the found key; and to determine from a recovery result or a verification result whether the identity verification is passed.

Preferably in a particular implementation, the seed information can be any information that can be processed by a computer system, e.g., known fixed information (e.g., a name, a fixed number, etc.), a random number, a time, a cumulative counter, etc., but the invention will not be limited thereto as long as the information can be processed using a key.

For the sake of a convenient description, for example, the seed information is the current time of the verification information generating device 11, so that the identity verifying server 12 can be configured to determine that the identity verification is passed, upon determining that the interval between the recovered current time of the verification information generating device 11 and the current time of the identity verifying server 12 lies in a preset time interval range; and can be further configured to determine that the identity verification is passed, upon determining that verification of the current time of the verification information generating device 11 is passed.

Preferably the user identity verification information generated by the verification information generating device 11 can include but will not be limited to a graphic code which can be a one-dimension code (a bar code) or a two-dimension code, where the two-dimension code includes a standard two-dimension code and a non-standard two-dimension code (i.e., some variant two-dimension code, e.g., a round two-dimension code, a color two-dimension code, etc.), but the invention will not be limited thereto. In a particular implementation, the verification information generating device 11 can include a security storage module, an operating module, and an electronic display that can display a graphic code, where the security storage module stores therein the key of the verification information generating device 11. Accordingly the verification information generating device 11 can generate the graphic code as follows for the identity verification to be performed:

The operating module processes the seed information into the processed seed information using the key pre-stored in the security storage module. In a particular implementation, the operating module can encrypt the seed information into cipher-text information corresponding to the seed information using the key stored in the security storage module; or the operating module can sign the seed information into the signed seed information using the key stored in the security storage module; or the operating module can perform a hash operation on the seed information to obtain a corresponding hash value.

The operating module generates a graphic code using the processed seed information (the cipher-text information or the signed seed information or the hash value above), and display the graphic code on the display of the verification information generating device 11. Thus the terminal device can scan the graphic code displayed by the verification information generating device 11 to obtain the processed seed information included in the graphic code. The terminal device carries the obtained processed seed information in an identity verification request sent to the identity verifying server 12 at the network side, and the identity verifying server 12 searches the locally stored keys for the key corresponding to the key stored in the verification information generating device 11, recovers and/or verifies the processed seed information using the found key, and determines from the recovery result or the verification result whether the identity verification is passed.

Preferably in a particular implementation, the identity verifying system according to an embodiment of the invention can be embodied in a symmetric key encryption architecture or can be embodied in an asymmetric key encryption architecture. If the identity verifying system is embodied in the symmetric key encryption architecture, then the keys stored in the security storage module are the same as the keys stored in the identity verifying server 12. If the identity verifying system is embodied in the asymmetric key encryption architecture, then a set of public and private keys can be generated randomly for each verification information generating device so that the private key is stored in the security storage module of the verification information generating device 11, and the public key is stored in the identity verifying server 12. As compared with the symmetric key encryption architecture, the asymmetric key encryption architecture can further improve the security of the identity verifying system, and in this case, even if the identity verifying server 12 is invaded, then an attacker cannot login by pretending a user.

Particularly in the asymmetric key encryption architecture, if the verification information generating device 11 signs the seed information using the private key, then the signed information can be verified using the public key stored in the identity verifying server 12; if the verification information generating device 11 encrypts the seed information using the private key, then the encrypted seed information can be decrypted into the seed information using the public key stored in the identity verifying server 12. In the symmetric key encryption architecture, if the verification information generating device 11 signs the seed information using the stored key, then the signed information can be verified using the key stored in the identity verifying server 12; if the verification information generating device 11 encrypts the seed information using the stored key, then the encrypted seed information can be decrypted into the seed information, and then verified, using the key stored in the identity verifying server 12, or the cipher text can be verified directly without being recovered; and if the verification information generating device 11 performs a hash operation on the seed information in a hash algorithm to obtain the hash value, then the identity verifying server 12 can verify the obtained hash value.

In an example where the seed information is the current time of the verification information generating device 11, if the interval of time between the recovered current time of the verification information generating device 11 and the current time of the identity verifying server 12 lies in a preset time interval range (which can be set a very short interval of time, for example), then it will be determined that the identity verification is passed; otherwise, it may be determined that the identity verification is not passed; or if it is determined that verification of the current time of the verification information generating device 11 is passed, then it may be determined that the identity verification is passed; otherwise, it may be determined that the identity verification is not passed.

In the method above, the identity verifying server 12 may search all the locally stored keys for the key corresponding to the key stored in the verification information generating device 11, and recover and/or verify the processed seed information, upon reception of the identity verification request of the terminal device. Particularly the identity verifying server 12 can attempt on each of the locally stored keys in sequence until it can recover and/or verify the processed seed information.

Preferably in order to improve the efficiency of the identity verifying server 12 to recover and/or verify the processed seed information, in the embodiment of the invention, the user identity verification information generated by the verification information generating device 11 can further include a device identifier of the verification information generating device 11 so that the terminal device can obtain the device identifier from the user identity verification information, and carry it together with the processed seed information in the identity verification request sent to the identity verifying server 12, and the identity verifying server 12 can search a pre-stored correspondence relationship between device identifiers and keys, for a key corresponding to the device identifier directly according to the device identifier, and determine it as the key corresponding to the key stored in the verification information generating device 11.

### Second Embodiment

For better understanding of the embodiment of the invention, a particular implementation of the embodiment of the invention will be described below in connection with an information interaction flow in identity verification, and for the sake of a convenient description, the embodiment of the invention will be described in an example where a user accesses an online bank, and FIG. 2 illustrates a flow in which the user logins the online bank, where the flow can include the following operations:

S21. The verification information generating device generates and displays a two-dimension code for verifying the identity of the user.

In a particular implementation, the user may access the online bank in the following two approaches:

In a First Approach:

The user accesses the online bank using the terminal device which obtains the user identity verification information, where, for example, the user accesses the online bank using a mobile phone, and also obtains the user identity verification information generated by the verification information generating device using the mobile phone. In this case, a logon page of the online bank accessed by the user may be provided with an application interface packaged using the identity verifying method according to the embodiment of the invention, and identity verification on the user may be triggered by invoking the application interface when the user needs to logon the online bank.

In a Second Approach:

The user accesses the online bank using a terminal device other than the terminal device which obtains the user identity verification information, for example, the user accesses the online bank using a computer, and obtains the user identity verification information generated by the verification information generating device using his or her own mobile phone. In this case, a logon page of the online bank may be embedded with verifying program packaged using the identity verifying method according to the embodiment of the invention, and the verifying program may be displayed on the logon page in the form of a graphic code (which can include but will not be limited to a two-dimension code), and if the user needs to logon the online bank, then the two-dimension code may be scanned directly to trigger identity verification on the user.

After identity verification on the user is triggered, the user triggers his or her own verification information generating device (which can be provided by the bank to the user when a bank account is registered for the user) to generate the user identity verification information, and for details thereof, reference can be made to the description in the first embodiment above, so a repeated description thereof will be omitted here.

Preferably in order to avoid a risk arising from a loss of the verification information generating device by the user, in the embodiment of the invention, the verification information generating device can further identify the user identity before generating the user identity verification information, where, for example, the verification information generating device can identify the user through his or her fingerprint, or can identify the user through a password preset by the user, although the invention will not be limited thereto; and correspondingly the verification information generating device can further include a digital button or fingerprint acquiring means.

S22. The terminal device scans the two-dimension code generated by the verification information generating device, and obtains information about the processed current time, and the device identifier of the verification information generating device.

In a particular implementation, in the first approach, the terminal can scan the user identity verification information generated by the verification information generating device by directly invoking the identity verification application enabled in the identity verifying method according to the embodiment of the invention. In the second approach, the user himself or herself starts the identity verification application, enabled in the identity verifying method according to the embodiment of the invention, installed in the terminal device to scan the user identity verification information generated by the verification information generating device.

S23. The terminal device sends an identity verification request to the identity verifying server at the network side.

Particularly the identity verification request carries the obtained processed seed information, and the device identifier of the verification information generating device. Moreover the terminal device may further carry an application identifier or an application name of an Internet application accessed by the user, and a globally unique identifier of the Internet application in the identity verification request, where the unique identifier is a globally unique code and will not be duplicated for any different Internet application, on any different terminal device, and at any different time. Preferably the unique code can include but will not be limited to a Universally Unique Identifier (UUID) or a Globally Unique Identifier (GUID), or of course, the unique code can alternatively be a similarly embodied global identifier, but for the sake of a convenient description, the unique code will be described as a UUID by way of an example.

If the user accesses an Internet application in the first approach, then the terminal device can directly obtain the application identifier or the application name of the Internet application currently accessed by the user, and the UUID corresponding to the Internet application, and send them together to the identity verifying server; and if the user accesses an Internet application in the second approach, then a graphic code displayed on the generated logon page may include the application identifier or the application name of the Internet application, and the UUID corresponding to the Internet application so that the terminal device can scan the graphic code to obtain the application identifier or the application name of the Internet application, and the UUID corresponding to the Internet application, and send them to the identity verifying server together with the processed seed information obtained from the two-dimension code generated by the verification information generating device, and the device identifier of the verification information generating device.

In a particular implementation, the terminal device can send the identity verification request to the identity verifying server at the network side over a wired network, a wireless network, a mobile communication network, etc.

S24. The identity verifying server searches for a corresponding key according to the device identifier carried in the identity verification request.

S25. The identity verifying server recovers and/or verifies the information about the processed current time using the found key.

S26. The identity verifying server performs identity verification.

In a particular implementation, in an example where the verification information generating device encrypts the current time, the identity verifying server compares the recovered current time of the verification information generating device with the current time of the identity verifying server, and if there is an interval of time lying in a preset time interval range, then it will be determined that the verification is passed; otherwise, it is determined that the verification is not passed.

S27. The identity verifying server sends a verification result to an application server providing the Internet application.

In a particular implementation, the identity verifying server provides the verification result to the application server corresponding to the application identifier or the application name carried in the identity verification request according to the application identifier or the application name, and carries the UUID of the Internet application currently accessed by the user in the sent verification result.

S28. The application server sends an Allow/Reject Access response message to the terminal device according to the verification result.

In a particular implementation, the application server determines the terminal device and the application, both of which are used by the user to access the Internet application, according to the UUID, and sends the Allow/Reject Access response message to the terminal device according to the verification result.

In a particular implementation, the identity verifying system according to the embodiment of the invention can provide one verification information generating device for different Internet applications, or can provide separate verification information generating devices for Internet applications requiring high security, e.g., an online bank, online payment, etc., and at this time the identity verifying server will maintain a correspondence relationship between the application identifiers of the Internet applications, the device identifiers of the verification information generating devices corresponding to the Internet applications, and the keys to provide identity verification for the different Internet applications.

It shall be noted that the terminal device as referred to in the embodiment of the invention can be a mobile phone, a tablet computer, a Personal Digital Assistant (PDA), a smart watch, and another mobile terminal device, or can be a Personal Computer (PC) or another device as long as the terminal device is provided with a camera device or a scanning device to scan the graphic code generated by the verification information generating device.

Moreover the Internet application as referred to in the embodiment of the invention, includes a website, an application client, etc., which can be accessed over the Internet/mobile Internet.

In the existing security system for which the encryption mechanism is adopted, the security of the asymmetric key encryption technology has been sufficiently proved in theory and widely applied. However the most obvious drawback thereof may lie in that the key is too long to be memorized and entered directly by a person so that the user typically needs to store the key in a computer file or a hardware device, and to import it for use, thus resulting in a risk of leaking the key and inconvenience to use. In the embodiment of the invention, the graphic code is a convenient machine automatic recognition technology to represent cipher-text information, and easy to recognize and transmit for decryption. This can address such a problem in the existing asymmetric key encryption mechanism that the key is too long to use directly. Moreover in the embodiment of the invention, the graphic code can be generated in separate hardware to thereby avoid the private key from being stolen, copied and tampered, and physically isolated from the Internet application accessed by the user to thereby avoid a possibility of being invaded by a hacker, thus achieving high security. Also in the embodiment of the invention, in the asymmetric key encryption mechanism, the private key is stored in the security storage module of the verification information generating device, and the public key is stored in the identity verifying server, so that even if the identity verifying server is invaded by a hacker, and the public key is leaked, then the attacker cannot be verified by falsifying the identity of any user, thus precluding any risk of security. Lastly since the key is sufficiently long and strong, the device identifier of the verification information generating device (which can be a unique number thereof) can be used directly as a username, and the identity can be verified using the cipher-text information generated by encrypting the seed information, or the signed information as a password each time, so that there will be a password for each time of verification, and the password will be far more complex than a password which is set by an ordinary person, thus greatly improving both the security and the convenience.

Thus as compared with the traditional identity verifying method, the identity verifying method according to the embodiment of the invention provides higher security, and offers a highly complex password for each time of verification to thereby avoid a risk of the password being stolen; and the identity verifying method according to the embodiment of the invention is more convenient and rapid because the user will not memorize and enter various different usernames and passwords but the graphic code can be scanned directly to thereby perform the identity verification process rapidly.

Since the password in the identity verifying method according to the embodiment of the invention is much longer and stronger than the password which is set by the ordinary user and the pure 6 digits used in the existing RSA-SecurID dual-factor authentication token, the password in the identity verifying method can be used directly as the primary password to verify the identity.

Moreover the identity verifying system according to the embodiment of the invention can be also applicable to an enterprise entrance guard system, where an enterprise may be equipped only with a graphic code scanning device (e.g., a camera), and every employee may be provided with a verification information generating device, thus the entering employee can be verified by scanning user identity verification information generated by the verification information generating device of the employee, and if the employee passes the verification, then he or she may be allowed to enter, and also the entrance opening time and other information can be recorded.

Based upon the same inventive idea, embodiments of the invention further provide identity verifying methods and apparatus, and related devices at the network side and the terminal side respectively, and since the methods, apparatuses and devices address the problem under a similar principle to the identity verifying system, reference can be made for the implementation of the method above for implementations of the methods, apparatuses and devices, so a repeated description thereof will be omitted here.

### Third Embodiment

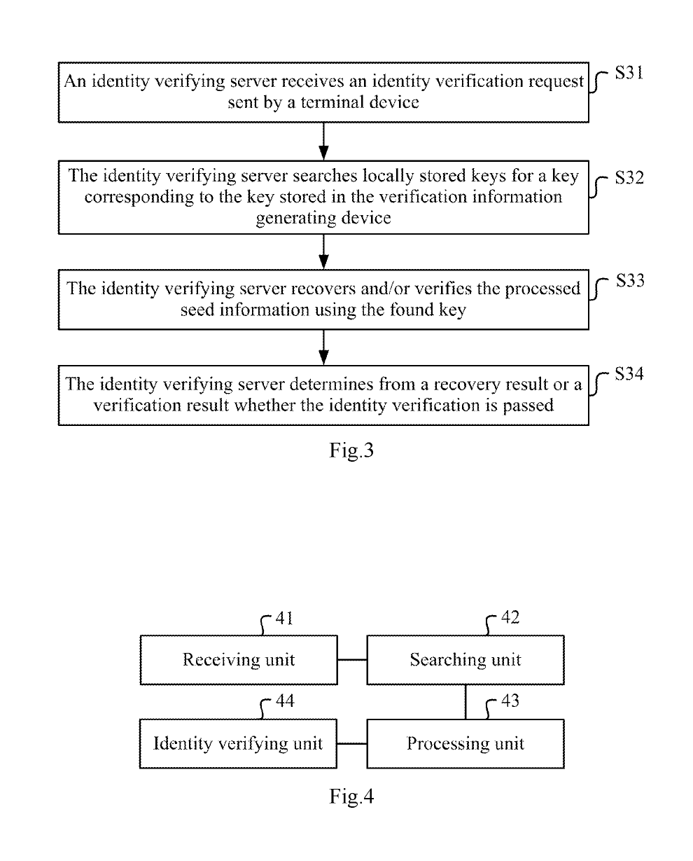

As illustrated in FIG. 3, there is a schematic flow chart of an implementation of an identity verifying method at the network side according to an embodiment of the invention, where the method includes:

S31. An identity verifying server receives an identity verification request sent by a terminal device.

Particularly the identity verification request carries user identity verification information obtained by the terminal device from a verification information generating device, and the user identity verification information includes at least processed seed information into which the verification information generating device processes seed information using a stored key, where the seed information is any information that can be processed by a computer system.

S32. The identity verifying server searches locally stored keys for a key corresponding to the key stored in the verification information generating device.

S33. The identity verifying server recovers and/or verifies the processed seed information using the found key.

S34. The identity verifying server determines from a recovery result or a verification result whether the identity verification is passed.

In a particular implementation, the user identity verification information further includes a device identifier of the verification information generating device; and the identity verification request further carries the device identifier; and

Searching the locally stored keys for the key corresponding to the key stored in the verification information generating device particular includes:

Searching a locally stored correspondence relationship between device identifiers and keys, for a key corresponding to the device identifier according to the device identifier; and

Determining the key corresponding to the device identifier as the key corresponding to the key stored in the verification information generating device.

In a particular implementation, the seed information can be any information that can be processed by a computer system, and preferably the seed information can include but will not be limited to current time of the verification information generating device; and

The identity verifying server can determine that the identity verification is passed, as follows:

It determines that the identity verification is passed, upon determining that an interval between the recovered current time of the verification information generating device and the current time lies in a preset time interval range; or determines that the identity verification is passed, upon determining that verification of the current time of the verification information generating device is passed.

In a particular implementation, the processed seed information is obtained by the verification information generating device encrypting, signing or performing a hash operation on the seed information using the stored key; and

Recovering and/or verifying the processed seed information using the found key particularly includes:

Decrypting the encrypted seed information into the seed information using the found key; or

Verifying the signed seed information using the found key; or

Verifying a hash value obtained by performing the hash operation on the seed information using the found key.

### Fourth Embodiment

As illustrated in FIG. 4, there is an identity verifying apparatus at the network side according to an embodiment of the invention, where the apparatus includes:

A receiving unit 41 is configured to receive an identity verification request sent by a terminal device, where the identity verification request carries user identity verification information obtained by the terminal device from a verification information generating device, the user identity verification information includes at least processed seed information into which the verification information generating device processes seed information using a stored key, and the seed information is any information that can be processed by a computer system;

A searching unit 42 is configured to search locally stored keys for a key corresponding to the key stored in the verification information generating device;

A processing unit 43 is configured to recover and/or verify the processed seed information using the key found by the searching unit 42; and

An identity verifying unit 44 is configured to determine from a recovery result or a verification result whether the identity verification is passed.

In a particular implementation, the user identity verification information further includes a device identifier of the verification information generating device; and the identity verification request further carries the device identifier; and

The searching unit 42 can be configured to search a locally stored correspondence relationship between device identifiers and keys, for a key corresponding to the device identifier according to the device identifier; and to determine the key corresponding to the device identifier as the key corresponding to the key stored in the verification information generating device.

Particularly the seed information can be any information that can be processed by a computer system, and preferably the seed information can include but will not be limited to current time of the verification information generating device; and

The identity verifying unit 44 can be configured to determine that the identity verification is passed, upon determining that an interval between the recovered current time of the verification information generating device and the current time lies in a preset time interval range; or to determine that the identity verification is passed, upon determining that verification of the current time of the verification information generating device is passed.

In a particular implementation, the processed seed information is obtained by the verification information generating device encrypting, signing or performing a hash operation on the seed information using the stored key; and

The processing unit 43 can be configured to decrypt the encrypted seed information into the seed information using the key found by the searching unit 42; or to verify the signed seed information using the key found by the searching unit 42; or to verify a hash value obtained by performing the hash operation on the seed information using the key found by the searching unit 42.

For the sake of a convenient description, the apparatus above have been functionally described as the respective modules (or units) thereof. Of course, in an implementation of the invention, the functions of the respective modules (or units) can be performed in the same one or more pieces of software or hardware. For example, the identity verifying apparatus according to the fourth embodiment above can be arranged in the identity verifying server.

### Fifth Embodiment

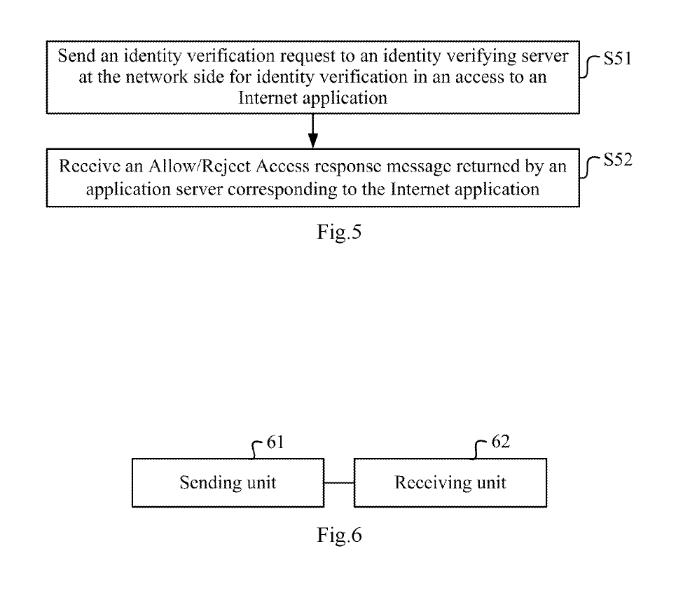

As illustrated in FIG. 5, there is a schematic flow chart of an implementation of an identity verifying method at the terminal side according to an embodiment of the invention, where the method can include:

S51 is to send an identity verification request to an identity verifying server at the network side for identity verification in an access to an Internet application;

The identity verification request carries user identity verification information obtained from a verification information generating device, and the user identity verification information includes at least processed seed information into which the verification information generating device processes seed information using a stored key, where the seed information is any information that can be processed by a computer system; and

S52 is to receive an Allow/Reject Access response message returned by an application server corresponding to the Internet application;

The response message is sent by the application server according to an identity verification result returned by the identity verifying server.

Preferably the user identity verification information can be a graphic code, and accordingly in the embodiment of the invention, the user identity verification information can be obtained from the verification information generating device as follows:

The graphic code displayed by the verification information generating device is scanned.

### Sixth Embodiment

As illustrated in FIG. 6, there is a schematic structural diagram of an identity verifying apparatus according to an embodiment of the invention, where the apparatus can include:

A sending unit 61 is configured to send an identity verification request to an identity verifying server at the network side for identity verification in an access to an Internet application, where the identity verification request carries user identity verification information obtained from a verification information generating device, the user identity verification information includes at least processed seed information into which the verification information generating device processes seed information using a stored key, and the seed information is any information that can be processed by a computer system; and

A receiving unit 62 is configured to receive an Allow/Reject Access response message returned by an application server corresponding to the Internet application, where the response message is sent by the application server according to an identity verification result returned by the identity verifying server.

Preferably if the user identity verification information is a graphic code, then the identity verifying apparatus at the terminal side according to the embodiment of the invention can further include: a scanning unit configured to scan the graphic code displayed by the verification information generating device.

For the sake of a convenient description, the apparatus above have been functionally described as the respective modules (or units) thereof. Of course, in an implementation of the invention, the functions of the respective modules (or units) can be performed in the same one or more pieces of software or hardware. For example, the identity verifying apparatus according to the sixth embodiment above can be arranged in the terminal device.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational operations are performed on the computer or the other programmable data processing device to create a computer implemented process so that the instructions executed on the computer or the other programmable device provide operations for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1-7. (canceled)

8. An identity verifying method, comprising:
receiving an identity verification request sent by a terminal device, wherein the identity verification request carries user identity verification information obtained by the terminal device from a verification information generating device, the user identity verification information comprises at least processed seed information into which the verification information generating device processes seed information using a stored key, and the seed information is any information that can be processed by a computer system;
searching locally stored keys for a key corresponding to the key stored in the verification information generating device;
recovering and/or verifying the processed seed information using the found key; and
determining from a recovery result or a verification result whether the identity verification is passed.

9. The method according to claim 8, wherein the user identity verification information further comprises a device identifier of the verification information generating device; and the identity verification request further carries the device identifier; and
searching the locally stored keys for the key corresponding to the key stored in the verification information generating device comprises:
searching a locally stored correspondence relationship between device identifiers and keys for a key corresponding to the device identifier according to the device identifier; and
determining the key corresponding to the device identifier as the key corresponding to the key stored in the verification information generating device.

10. The method according to claim 8, wherein the seed information is current time of the verification information generating device; and
determining that the identity verification is passed comprises:
determining that the identity verification is passed, upon determining that an interval between the recovered current time of the verification information generating device and the current time lies in a preset time interval range; or
determining that the identity verification is passed, upon determining that verification of the current time of the verification information generating device is passed.

11. The method according to claim 8, wherein the processed seed information is obtained by the verification information generating device encrypting, signing or performing a hash operation on the seed information using the stored key; and
recovering and/or verifying the processed seed information using the found key comprises:
decrypting the encrypted seed information into the seed information using the found key; or
verifying the signed seed information using the found key; or
verifying a hash value obtained by performing the hash operation on the seed information using the found key.

12. An identity verifying apparatus, comprising:
a receiving unit configured to receive an identity verification request sent by a terminal device, wherein the identity verification request carries user identity verification information obtained by the terminal device from a verification information generating device, the user identity verification information comprises at least processed seed information into which the verification information generating device processes seed information using a stored key, and the seed information is any information that can be processed by a computer system;
a searching unit configured to search locally stored keys for a key corresponding to the key stored in the verification information generating device;
a processing unit configured to recover and/or verify the processed seed information using the key found by the searching unit; and
an identity verifying unit configured to determine from a recovery result or a verification result whether the identity verification is passed.

13. The apparatus according to claim 12, wherein the user identity verification information further comprises a device identifier of the verification information generating device; and the identity verification request further carries the device identifier; and
the searching unit is configured to search a locally stored correspondence relationship between device identifiers and keys for a key corresponding to the device identifier according to the device identifier; and to determine the key corresponding to the device identifier as the key corresponding to the key stored in the verification information generating device.

14. The apparatus according to claim 12, wherein the seed information is current time of the verification information generating device; and
the identity verifying unit is configured to determine that the identity verification is passed, upon determining that an interval between the recovered current time of the verification information generating device and the current time lies in a preset time interval range; or to determine that the identity verification is passed, upon determining that verification of the current time of the verification information generating device is passed.

15. The apparatus according to claim 12, wherein the processed seed information is obtained by the verification information generating device encrypting, signing or performing a hash operation on the seed information using the stored key; and
the processing unit is configured to decrypt the encrypted seed information into the seed information using the key found by the searching unit; or to verify the signed seed information using the key found by the searching unit; or to verify a hash value obtained by performing the hash operation on the seed information using the key found by the searching unit.

16. The apparatus according to claim 12, wherein the identity verifying apparatus is enclosed in an identity verifying server.

17. An identity verifying method, comprising:
sending an identity verification request to an identity verifying server at the network side for identity verification in an access to an Internet application, wherein the identity verification request carries user identity verification information obtained from a verification information generating device, and the user identity verification information comprises at least processed seed information into which the verification information generating device processes seed information using a stored key, wherein the seed information is any information that can be processed by a computer system; and
receiving an Allow/Reject Access response message returned by an application server corresponding to the Internet application, wherein the response message is sent by the application server according to an identity verification result returned by the identity verifying server.

18. The method according to claim 17, wherein the user identity verification information is a graphic code, and
the user identity verification information is obtained from the verification information generating device by:
scanning the graphic code displayed by the verification information generating device.

19. An identity verifying apparatus, comprising:
a sending unit configured to send an identity verification request to an identity verifying server at the network side for identity verification in an access to an Internet application, wherein the identity verification request carries user identity verification information obtained from a verification information generating device, the user identity verification information comprises at least processed seed information into which the verification information generating device processes seed information using a stored key, and the seed information is any information that can be processed by a computer system; and
a receiving unit configured to receive an Allow/Reject Access response message returned by an application server corresponding to the Internet application, wherein the response message is sent by the application server according to an identity verification result returned by the identity verifying server.

20. The apparatus according to claim 19, wherein the identity verification information is a graphic code; and
the apparatus further comprises:
a scanning unit configured to scan the graphic code displayed by the verification information generating device.

21. The apparatus according to claim 19, wherein the apparatus is enclosed in a terminal device.

22. The apparatus according to claim 13, wherein the identity verifying apparatus is enclosed in an identity verifying server.

23. The apparatus according to claim 14, wherein the identity verifying apparatus is enclosed in an identity verifying server.

24. The apparatus according to claim 15, wherein the identity verifying apparatus is enclosed in an identity verifying server.

25. The method according to claim 18, wherein the graphic code comprises a one-dimension code or a two-dimension code.

26. The apparatus according to claim 20, wherein the graphic code comprises a one-dimension code or a two-dimension code.

27. The apparatus according to claim 20, wherein the apparatus is enclosed in a terminal device.
